(19) United States
(12) Patent Application Publication
(10) Pub. No.: US 2018/0264757 A1
(43) Pub. Date: Sep. 20, 2018

(54) METHOD FOR FAST MOLDING FLEXIBLE PLASTIC ON FABRIC AND PRODUCT THEREOF

(71) Applicant: UNIVERSAL TRIM SUPPLY CO., LTD., New Taipei City (TW)

(72) Inventor: SHIH-SHENG YANG, New Taipei City (TW)

(21) Appl. No.: 15/460,223

(22) Filed: Mar. 15, 2017

(51) Int. Cl. B29C 70/48; B29C 65/48; B32B 27/12; B32B 37/12; B32B 38/10

(52) U.S. Cl. CPC B29C 70/48; B29C 65/48; B32B 27/12; B29L 2031/722; B32B 38/10; B29K 2913/00; B32B 37/12

(57) ABSTRACT

Disclosed a method for fast molding a flexible plastic on a fabric and a product thereof. A fabric on which molding is to be applied is provided with a bottom paper that is temporarily and adhesively attached to a bottom surface of the fabric. The fabric and the bottom paper are collectively punched to form material feeding holes corresponding to mold cavities and are then collectively clamped in a mold that includes at least two mold blocks for injection molding. The first mold block includes multiple dot-like mold cavities formed thereon and arranged in a predetermined pattern. The second mold block includes channel-like cavities thereon for a plastic material to flow therethrough. Injection is conducted to mold the flexible plastic such that the plastic is forced, under impact by high temperature and high pressure, into a surface of the fabric and thus molded thereon.

### (a) TECHNICAL FIELD OF THE INVENTION

The present invention relates generally to a method for fast molding a flexible plastic on a fabric and a product thereof, and more particularly to a processing method for fast combining a flexible plastic object having raised dots to a surface of a piece of fabric, which is particularly applicable to a product of of logo or mark or a design of a decoration having anti-skidding effect so as to provide, when tied in with the flexible property of the fabric, demonstration of improved adaptability and unique perception of tactility.

### (b) DESCRIPTION OF THE PRIOR ART

Decoration representing a logo or mark attached to a fabric product is often achieved with for example needlework. With continuous emergence of new products and also the progress of processing techniques, diverse products that involve logos or marks formed by combining plastics on fabrics are available. One the most commonly used processes for combining plastics and fabrics is ultrasonic wave based processing methods, which apply ultrasonic waves to fuse a plastic object on a fabric for bonding together. However, since fabrics that is formed through knitting or weaving often exhibit flexibility and demonstrates a property of extendibility/contractibility. This makes the combination strength achieved with the ultrasonic wave based processes very limited and thus insufficiency of stability is always a concern.

Other processes, which apply injection molding to have plastics directly attached to fabrics, are also available. These processes are generally only applicable to logos or marks in the form of a block or a complete piece. For logos or marks that are displayed with dots or raised spots, a plate must be provided as a bottom base and a pattern or figure formed of dots or raised spots is then formed or molded on the plate. This apparently affects overall comfortableness and perceptive effect of vision and tactility. In addition, these processes are generally not applicable to fabric products that involve a large area of skidding-resistance effect.

The known processes of combining plastics with fabrics as discussed above do not suit the need for formation of a pattern formed of an arrangement of raised dots.

### SUMMARY OF THE INVENTION

Thus, the primary object of the present invention is to provide a method for fast molding a flexible plastic on a fabric and a product thereof, which provides an efficient and easy process for molding and securely attaching a flexible plastic object having a plurality of raised dots to a surface of a fabric in order to exhibit a logo or mark or to achieve a design of a decoration with an anti-skidding effect, and also to enhance unique sense of touch of the product and adaptability thereof.

To achieve the above object, the present invention provides a method for fast molding a flexible plastic on a fabric, which generally comprises the following steps:

(a) adhering bottom paper and punching holes: a piece of fabric having a predetermined size being adhesively attached with a temporarily and adhesively attached bottom paper on a bottom surface thereof and the fabric and the bottom paper being collectively subjected to punching to form material feeding holes corresponding to mold cavities;

(b) clamping in mold: clamping the fabric that comprises the bottom paper adhesively attached thereto and comprises material feeding holes formed therein in an injection mold that comprises at least two mold blocks, wherein the mold blocks have mold jointing surfaces that are respectively provided with a plurality of dot-like mold cavities that are arranged in a predetermined pattern and channel-like cavities that correspond to the dot-like mold cavities to allow a plastic material to flow therethrough, where the fabric is arranged to face the dot-like mold cavities and the bottom paper faces the channel-like cavities;

(c) molding processing: pouring and feeding, through mold pressurization, a flexible plastic that is mixed with or comprises a substance having a composition different from the fabric but having a similar molecular structure into the forming mold cavities so that under impact of high temperature and high pressure of mold pressurization, the plastic material is forced to flow through the channel-like cavities into the corresponding dot-like mold cavities and penetrating into the surface of the fabric for being molded; and

(d) peeling off bottom paper to provide finished product: removing the fabric after the molding operation and peeling the bottom paper that is located on the bottom, together with strips molded and shaped in the channel-like cavities, to complete a product through fast molding the flexible plastic on the fabric.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram illustrating a flow chart of the present invention.

FIG. 2 is a schematic view illustrating step a of the present invention.

FIG. 3 is a schematic view illustrating a first mold block of step b of the present invention.

FIG. 3A is a perspective view illustrating a dot-like mold cavity of the first mold block of step b of the present invention.

FIG. 4 is a schematic view illustrating a forming mold of step b of the present invention.

FIG. 5 is a schematic view illustrating a second mold block of step b of the present invention.

FIG. 5A is a perspective view illustrating a channel-like mold cavity and runners of the second mold block of step b of the present invention

FIG. 6 is a cross-sectional view illustrating molding of step c of the present invention.

FIG. 7 is a schematic view illustrating step d of the present invention.

FIG. 7A is a perspective view illustrating a molded product of plastic and fabric after molding of step c of the present invention.

FIG. 8 is a perspective view illustrating a fabric product of the present invention.

FIG. 8A is an enlarged view of a circled portion of the fabric product that is combined with plastic.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

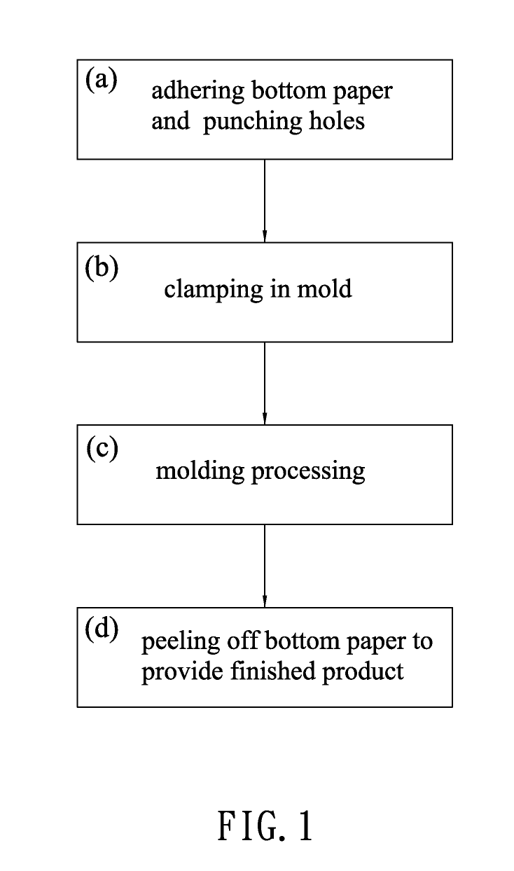

Referring to FIG. 1, a flow chart illustrating a method for fast molding a flexible plastic on a fabric is provided, generally comprising the following steps: (a) adhering bottom paper and punching holes, (b) clamped in mold, (c) injection molding, and (d) peeling off bottom paper to provide finished product.

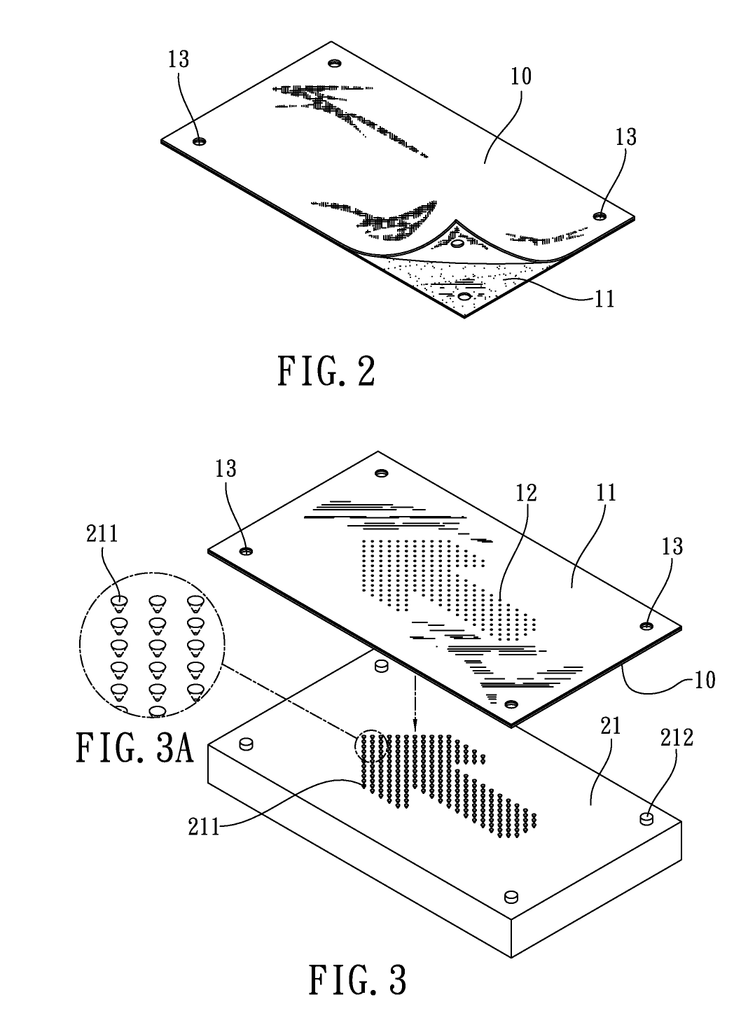

Referring collectively to FIGS. 1-8 for explanation of the above listed steps as follows:

(a) adhering bottom paper and punching holes: a bottom paper 11, which has backside adhesive for temporary bonding through adhesion and allowing for ready removal, being first provided and adhesively attached to a bottom surface of a fabric 10 having a predetermined size and having a surface that is formed, through punching, with a plurality of material feeding holes 12 (as shown in FIG. 3), which correspond to mold cavities 211 of a forming mold 20 and have a diameter that is smaller than a diameter of the mold cavities 211, for the purpose of material flowing therethrough, wherein in an alternative embodiment, based on the requirement of use for a final product, backside adhesive may be applied on the bottom surface of the fabric 10 and then, the bottom paper 11 is adhesively attached to the bottom surface of the fabric 10, whereby after completion of a manufacturing process, the bottom paper 11 can be peeled off to allow the finally-formed product to exhibit adhesion on the back side thereof for direct adhesive attachment for use. Thus, whether the bottom surface of the fabric is provided with back adhesive for adhesion while the back side of the bottom paper is provided with no back adhesive, or the bottom surface of the bottom paper is coated with back adhesive for adhesion, while the bottom surface of the fabric has no back adhesive, these ways of embodiment are all considered falling within the scope of the present invention.

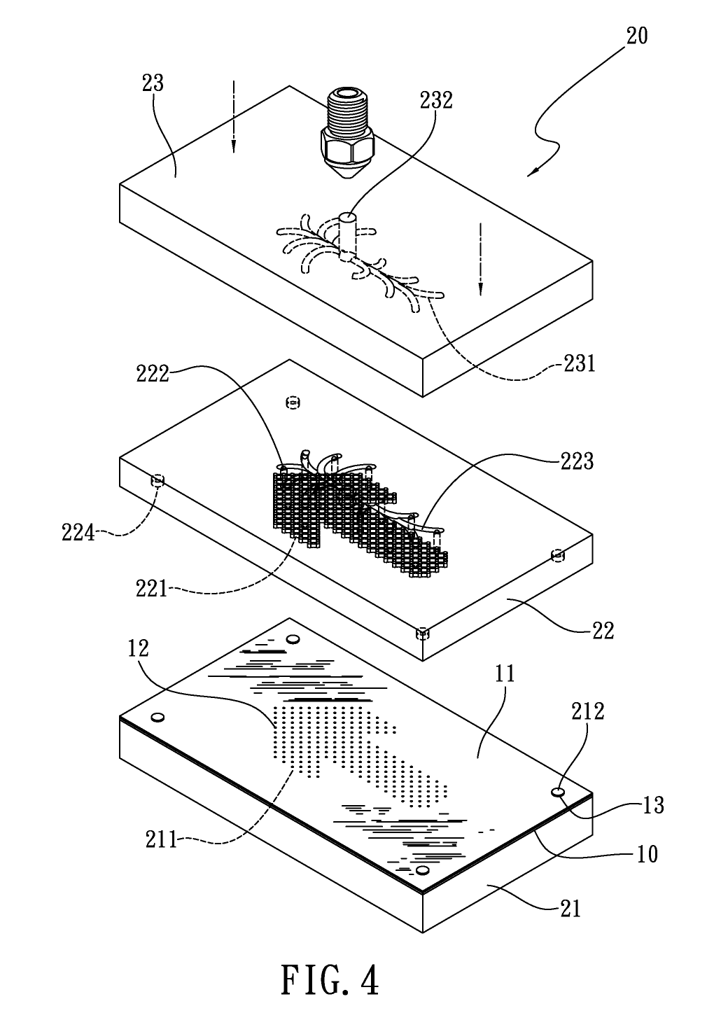

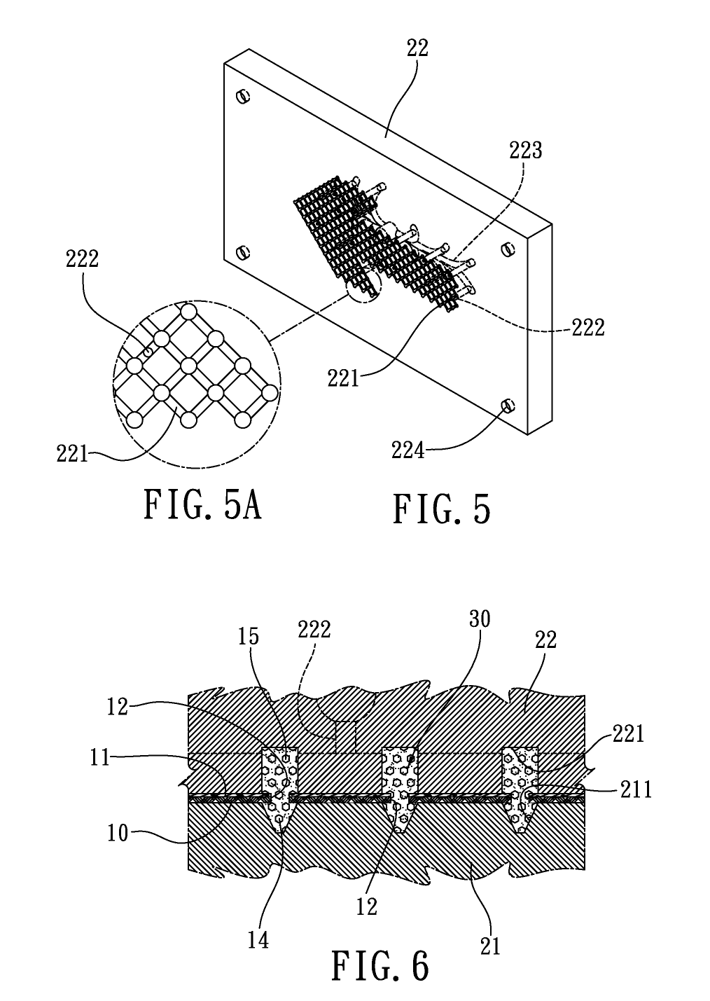

(b) clamping in mold: the fabric 10 comprising the bottom paper 11 attached thereto and comprising the plurality of holes 12 for material flowing is clamped and securely held in an injection mold 20 (as shown in FIG. 4), wherein the mold is composed of at least a first mold block 21 and a second mold block 22, where the first mold block 21 has a mold jointing surface on which a design of pattern comprising a predetermined figure is formed and the figure is formed by an array of properly arranged dot-like mold cavities 211 and the fabric 10 is disposed such that a surface thereof faces such a specific side (as shown in FIG. 3), and the second mold block 22 is provided with channel-like cavities 221 corresponding to the dot-like mold cavities 211 for flowing of material, the bottom paper 11 of the fabric 10 being arranged to face such a specific side, the channel-like cavities 221 being provided, at suitable sites thereof, with runners 222 for material feeding (as shown in FIG. 5), wherein in the preferred embodiment, molding material feeding is of a three-plate needle point feeding spruce design that allows for convenient and stable and uniform material feeding, where a side of the second mold block 22 that is opposite to the joint surface thereof is provided with a de-molding plate 23, and spruces (223, 231) being provided therebetween for connection with needle point material feeding runners 222, an opposite side of the de-molding plate 23 being provided with a feeding hole or gate 232 for feeding or pouring the material into the forming mold 20. Further, the instant embodiment is further constructed to provide positioning pillars 212 and positioning troughs 224 on a circumferential margin edge of the jointing surfaces of the first mold block 21 and the second mold block 22, while the fabric 10 and the bottom paper 11 are provided with retention holes 13 formed therethrough for positioning and retaining in order to achieve accurate and firm positioning thereof in the mold 20.

(c) molding processing: the mold being closed to have the fabric 10 that comprises the bottom paper 11 adhesively attached thereto clamped and retained in the injection mold 20, wherein a flexible plastic material 30 comprising a substance having a composition different from the fabric 10 but having a similar molecular structure is molded through pouring and feeding through a sprue and runner system into the forming mold 20 and flowing through the channel-like cavities 221 to sites respectively corresponding to the dot-like mold cavities 211, whereby due to high-pressure and high-temperature impact resulting from molding operation, the plastic material 30 is forced to move into the feeding holes 12 and penetrate into the dot-like mold cavities 211 on the surface of the fabric 10 so that molecules of both the plastic material 30 and the fabric 10 are caused by the high temperature to exhibit a fused condition and thus tightly bonded and coupled together to form a desired figure having a predetermined pattern of raised dots 14 (as shown in FIGS. 6, 7, and 8).

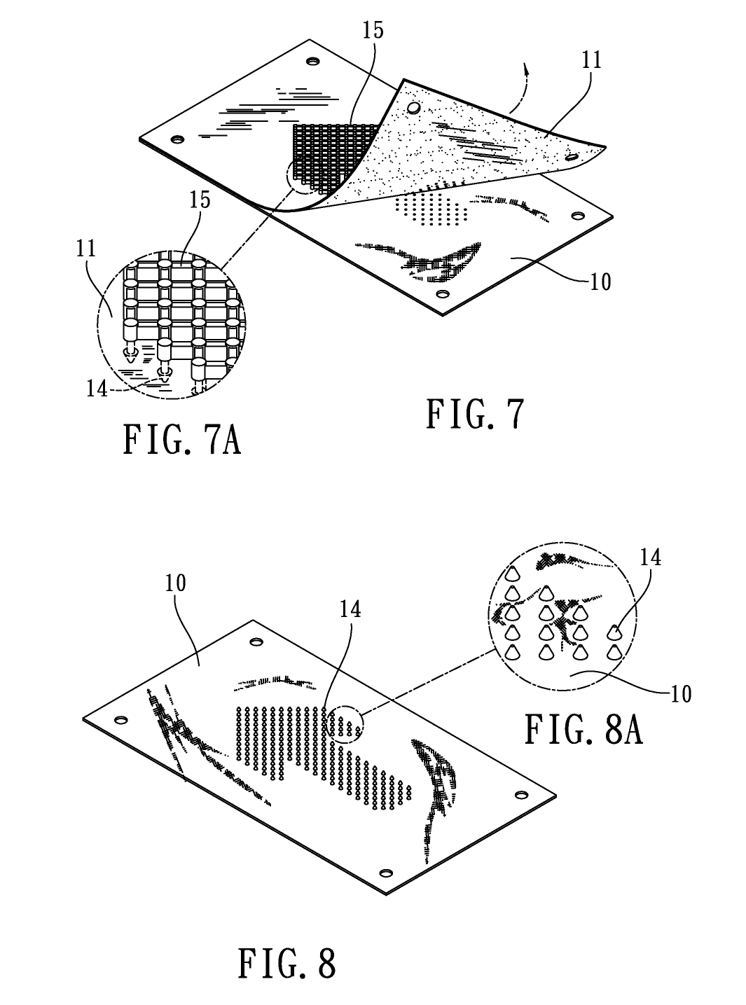

(d) peeling off bottom paper to provide finished product: the mold being opened after the molding operation, the de-molding plate 23 being used to first separate and remove the plastic material 30 molded in the sprues (223, 231) so that when the fabric 10 is retrieved, only the raised dots 14 of the desired figure is preserved on the surface of the fabric 10, wherein with the relatively small diameter of the feeding holes 12 connected to strips 15 formed in the bottom paper 11, when the bottom paper 11 is peeled from the bottom or underside of the fabric 10, the small-diameter connection parts can be easily broken at the same time when the bottom paper 11 is peeled off and the strips 15 would be simultaneously removed (as shown in FIG. 7), with only the figure that is displayed with the raised dots 14 on the surface of the fabric 10 being preserved, and the bottom surface or undersurface of the fabric 10 being made a flat planar surface without no additional or excessive or residual injected plastic attached thereto (as shown in FIG. 8). With the above steps, a product manufactured through the process of fast molding a flexible plastic on a fabric is provided.

Referring to FIG. 8, the present invention provides a product of the method for fast molding a flexible plastic on a fabric and the product comprises, structurally, a piece of fabric 10, and a plurality of raised flexible plastic dots 14 that are integrally formed on a surface of the fabric 10 such that the raised dots 14 are arranged and arrayed to exhibit a design of a pattern comprising a specific figure and an undersurface or bottom surface of the fabric 10 is a flat planar surface with no additional or excessive or residual injected plastic attached thereto.

In summary, the present invention provides a method for fast molding a flexible plastic on a fabric that involves a simplified and easy process and allows for formation of a flexible plastic figure composed of a plurality of raised dots molded on a surface of a product to provide an advertisement of exhibiting a logo or a mark, and being also applicable to a design of a decoration having an effect of skidding protection so as to enhance unique sense of touch of the product and adaptability thereof. It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A method for fast molding a flexible plastic on a fabric, comprising the following steps:
(a) adhering bottom paper and punching holes: a piece of fabric having a predetermined size being adhesively attached with a temporarily and adhesively attached bottom paper on a bottom surface thereof and comprising material feeding holes formed, through punching, in a surface thereof to respectively correspond to mold cavities;
(b) clamping in mold: providing a mold comprising at least two mold blocks comprising first and second mold blocks, wherein the first mold block has a mold jointing surface on which an arrangement of a plurality of dot-like mold cavities is provided to exhibit a predetermined pattern and the second mold block is provided with channel-like cavities corresponding thereto for plastic to flow therethrough, where the cavities are provided with runners in connection with sprues, the fabric being positioned facing the first mold block and the bottom paper facing the second mold block and clamped and held in the mold for injection molding;
(c) molding processing: a flexible plastic comprising a substance having a composition different from the fabric but having a similar molecular structure being pour and fed into the forming mold cavities so that under an impact of high temperature and high pressure, the plastic is forced to flow through the channel-like cavities to the dot-like mold cavities and moving through the feeding holes to penetrate to the surface of the fabric to get molded and exhibit the predetermined pattern; and
(d) peeling off bottom paper to provide finished product: removing the fabric and peeling off the bottom paper on the bottom surface thereof, together with strips that are molded with the channel-like cavities so that only the predetermined pattern molded on the surface of the fabric is preserved;
wherein through the above steps, the method for fast molding a flexible plastic on a fabric is completed.

2. The method for fast molding a flexible plastic on a fabric according to claim 1, wherein the material feeding holes formed in the surface of the combined fabric and bottom paper have a diameter that is smaller than a diameter of the mold cavities.

3. The method for fast molding a flexible plastic on a fabric according to claim 1, wherein the fabric and the bottom paper are provided in a margin edge area thereof with retention holes and the mold jointing surfaces of the mold blocks are provided with positioning pillars and positioning troughs for positioning purpose.

4. The method for fast molding a flexible plastic on a fabric according to claim 1, wherein the fabric has a bottom surface on which back adhesive exhibiting adhesion is coated and a bottom surface of the bottom paper comprises no back adhesive.

5. The method for fast molding a flexible plastic on a fabric according to claim 1, wherein the bottom paper has a bottom surface on which back adhesive exhibiting adhesion is provided and a bottom surface of the fabric comprises no back adhesive.

6. A product formed through molding a flexible plastic on a fabric, wherein the fabric has a surface and a plurality of raised dots formed of the flexible plastic is molded and thus integrally combined with the surface of the fabric, the raised dots being arranged to form a predetermined pattern, the fabric having a bottom surface that is a flat planar surface with no residual plastic located thereon through injection.

7. The product according to claim 6, wherein the raised flexible plastic dots that are arranged in a predetermined pattern display a logo or mark or provide an effect of skidding resistance.

8. The product according to claim 6, wherein the bottom surface of the fabric is provided with back adhesive exhibiting adhesion.
